(19) United States
(12) Patent Application Publication
(10) Pub. No.: US 2004/0233285 A1
(43) Pub. Date: Nov. 25, 2004

(54) Video system as method ensuring the safe driving of cars

(76) Inventors: Katie Seleznev, West Hartford, CT (US); Stanislav Vitruk, West Hartford, CT (US)

Correspondence Address: Katie Seleznev, 149 Brewster Road, West Hartford, CT, 06117, US

(21) Appl. No.: 10/443,259

(22) Filed: May 22, 2003

(51) Int. Cl. H04N 7/18

(52) U.S. Cl. 348/148; 348/139

(57) ABSTRACT

The present invention relates to means of ensuring a safety of the driving of automobiles and includes Video System, enabling for a driver, without changing his posture at the steering wheel, to have the sheer view of an area. Video System is the new method in the achievement of an observation of a locality and also of the analysis with a driver all, what has taken place around the car. A locality from the front the driver watches visually, all situated on the car's right and left sides and from behind he observes on screen picture. The sheer visibility around a car allows a driver completely check a situation and in case of a need to maneuver to avert accidents.

### BACKGROUND OF THE INVENTION

1. Technical Field

The present invention is an idea of employment of Video System as a new method in the decision of the problem of the sheer, without blind spots, driver's observation of a locality around a car as one in principal requirements to achieve the safety on roads.

2. Background Art

The safety of the driving depends in many respects on the viewing area around the car. The visibility of objects enables to take with a driver the correct decisions about his/her car's maneuvers and evade the collisions with objects, which prevent from the car's movement.

Installed on modern cars the system of mirrors as the method of widening of the view of an area doesn't ensure a driver with complete volume of objective data about the situation, which occurs on the locality around the car, through the existence of blind spots (the locality, which at the given moment is out of the driver's view). And this leads often to accidents. By the system of mirrors, the view of an area in front of the car makes visually, the locality at the back is reflected in the rear view mirror, but the bigger its part gets into the blind spot. Moreover, at the inner arrangement of the rear view mirror, the blind spot extends, owing to parts of the car's design and also existing inside the car passengers and different objects.

The blind spot decreases a few in the time of the simultaneous employment of the rear view mirror and door mirrors. During the driver's turn back with his body and head, the blind spot decreases, but only on the half of the rear view. The second half of the locality from behind and the side of the car and the entire locality in front fall out in this moment from the driver's sight. That is to say get into the blind spot.

Proposed at last time, convex near—view mirrors of cars also don't solve a problem of an abolition of blind spots, although the decrease of them is a few. Moreover, convex mirrors, situated close by the windscreen at the acute angle to a driver's eye, have on it the unfavorable influence.

Thus, the system of mirrors and a driver's turn to the back don't eliminate blind spots and don't prevent connected with this accidents.

The purpose of the present invention is an adoption in the automobile industry a new method, which firstly decides the problem of the sheer viewing of an area around a car by the substitute of the imperfect system of mirrors on the Video System; secondly, it intends to install the video camera on the car's outside because this enables to realize the sheer (without invisible plots) view of the locality of a sufficient area; thirdly, on the strength of images on the video screen of monitor, situated on an instrument panel a little to the side of the steering wheel, a driver is able to carry out an objective, controllable, and guided analysis of taking place around the car situations and to choose the right, safe version of maneuvering during the cars' traffic.

### SUMMARY OF THE INVENTION

The present invention includes Video System as car's completing part for the achievement of its safe driving by making conditions for sheer, without blind spots, view of the area around a car. This new method is offered instead of the used at present in cars, but not a perfect method in a state of a system of mirrors.

The employment on cars Video System is a new method, which brings radical changes in the ensuring of the sheer observation of the necessary area around a car, owing to the removal of blind spots enables for a driver to analyze easily and confidently -the situation and carry out correctly the car's maneuvering, and thanks to this, escape accidents.

Video System consists of the installed outside of the car the camera with a lens at the angle of view no less than 120 degrees and with night vision diodes, and of the installed inside on the instrument panel from the front and right of the steering wheel the monitor with the video screen, reflecting a locality around a car.

The exterior arrangement of cameras allows for a driver to have the sheer view of an area and to reveal objects, which are near the car, and this is the main prerequisite in the decision of practical task to obtain the motion on roads without accidents because a threat for the car create only objects quite near to it at present.

In the decision of practical task of the improvement of safety's level on roads, it is extremely important the singling out on the video screen the breakdown zone. The appearance on it any objects warns the driver of a danger for the car in case of its wrong maneuvering. When a driver discovers in this zone objects, which threaten for his car with emergency situation, he comes to timely decision to prevent an accident.

Video System works from the car's power grid, switching on and off together with an engine. Video System facilitates essentially a job of a driver, from which before the car's maneuvering doesn't require already to form a correct estimate of the surrounding situation analyze data from several mirrors in combination with seen during changing of the position of his body and head. On the video screen, situated in front of the steering wheel, before the driver's glance appears an area with details, moving and motionless objects near and far from a car. This instills the confidence in objective estimate of the situation and enables for a driver to carry out the reliable, without accidents maneuvering during a car's movement.

### BRIEF DESCRIPTION OF THE DRAWINGS

FIG. 1 is the car's exterior view with video camera, installed from the front of the windscreen;

FIG. 2 is the car's exterior view with the attachment of video cameras at fore of front doors and to the lower part of the rear window's frame;

FIG. 3 is the car's exterior view with the video camera with combined lens, attached to the roof above a windscreen;

FIG. 4A is the exterior view from the front of the cabinet with the camera and the removable hand, installed at fore of the windscreen;

FIG. 4B is the exterior view from the front of the cabinet with the camera and removable hand, installed on right and left at fore of front doors;

FIG. 4C is the exterior view from the front of the cabinet with the camera and removable hand, attached to the roof above a windscreen or to the rear window's frame;

FIG. 5 is the scheme of a basic principle of Video System's functioning in the view of an area;

FIG. 6 is the scheme of a possible situation with moving objects on viewable locality and a decision of this situation without an accident owing to the video camera, installed from the front;

FIG. 7 is the scheme of a possible situation with moving objects on viewable locality and a decision of this situation without an accident owing to video cameras, attached at fore of front doors and on the lower part of the rear window's frame;

FIG. 8 is the scheme of the sheer view of an area around the car owing to the video camera with combined lens, attached to the roof above a windscreen.

### DETAILED DESCRIPTION OF THE PREFERRED EMBODIMENTS

The present invention puts into practice one from principal task in ensuring of a car's safe driving with the aid of Video System as a new method achieving the sheer, without blind spots, observation of an area. Owing to this, a driver enables to analyze completely and objectively all, what occurs around the car, and choose an optimal version to maneuver during the car's movement, avoiding in this time accidents. Video System is intended for the substitution of the used now system of mirrors, since it doesn't eliminate blind spots and thereby doesn't ensure a complete appraisement of a situation on a locality around the car. Meanwhile, just from the timely discovery of objects, which are near the car, often depends a prevention of accident situations. This important practical task decides an installation on cars Video System, ensuring the sheer back and lateral view of an area surrounding the car.

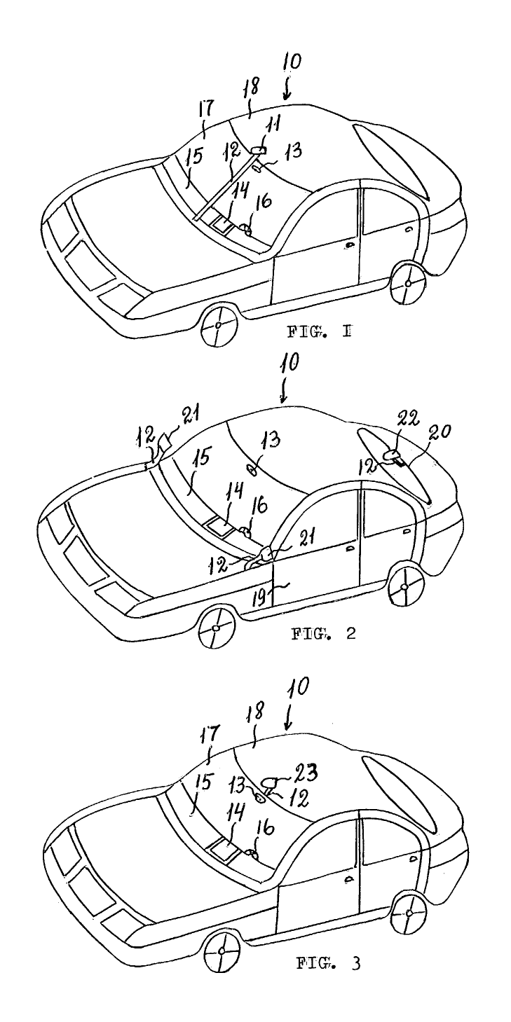

The car's exterior view with Video System is shown in FIG. 1, where there is one video camera 11, and in FIG. 2, where is displayed a version with three video cameras—the left and the right 21, installed on the outside at fore of the car's front doors 19, and the rear 22, attached to the lower part of a rear window's frame 20. Instead of these three cameras can be one camera 23 (FIG. 3) with two lenses, installed on the roof 18 above a windscreen 17. With all these versions of the placing of video cameras is the monitor with a video screen 14, attached inside a car's saloon on an instrument panel 15 on the right of the steering wheel 16.

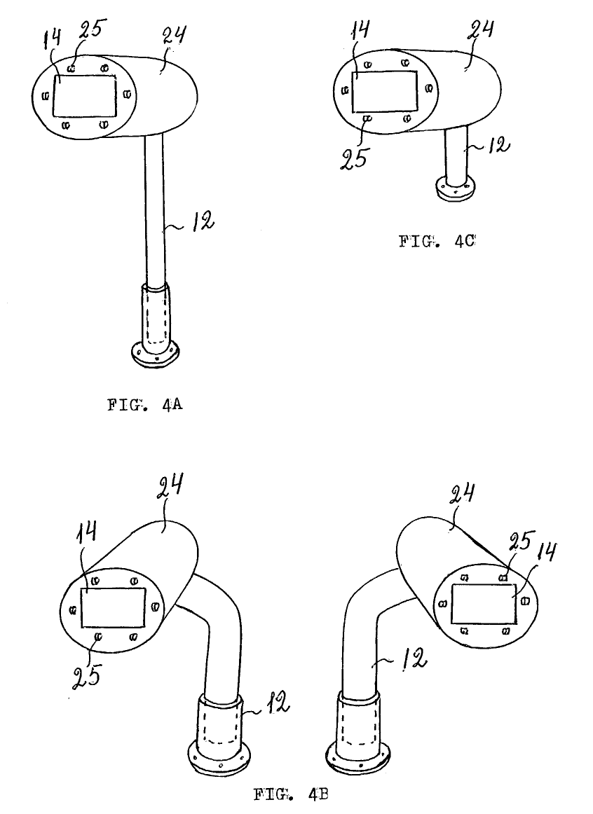

Video cameras are situated in a box 24, which is fastened with the hand 12 to the car's body. The hand's 12 form, how is showed in FIGS. 4A, B, C, changes depending on a place of the installation of a video camera on a car.

The installation of a video camera on the car's outside is a sole and indispensable condition enabling to get the sheer, without blind spots, the view of an area. Cameras are provided with wide-angle lens with an angle of an embracement no less than 120 degrees, and this broadens the back and side viewing of an area. Cameras are equipped with Night Vision Light-Emitting Diodes 25 allowing to achieve automatically an even viewing in the nighttime.

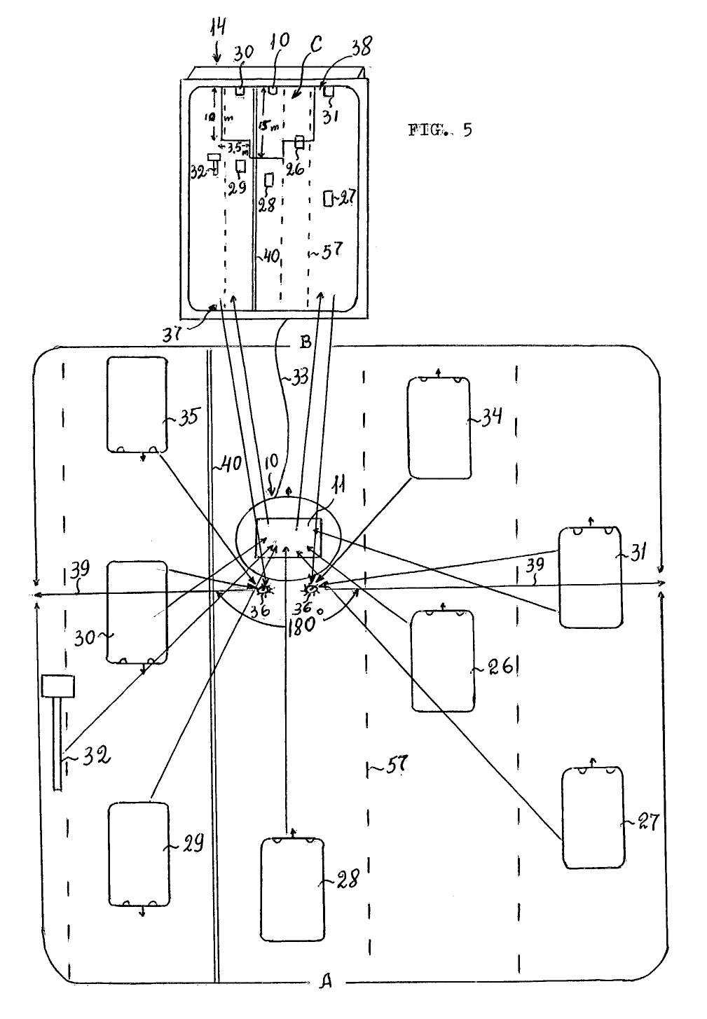

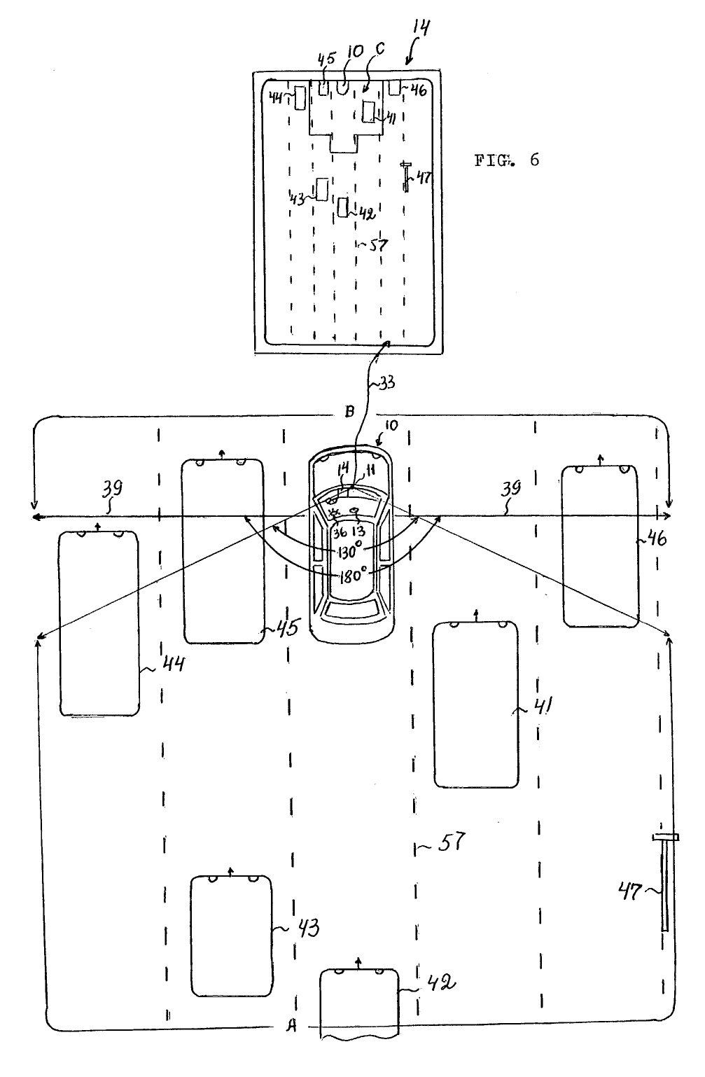

The main principle of Video System's functioning, how shows FIG. 5, is the rendering in the camera 11 of the car 10 reflections of a relief of an area A and situated on it objects 26, 27, 28, 29, 30, 31, 32, and then the rendering 33 these images from video camera 11 on video screen 14. Objects 34, 35, situated in the front of the car, get to visual field of the vision (a locality B surveyed with eyes 36). Objects, situated at a distance under 300 meters to a video camera 11, appear on the video screen 14 in the liquid crystal color look. On the video screen 14 they are situated as follows: the most remote objects 27, 28,29 are below 37, the most near 26, 30, 31 from above 38. Objects 30, 31 at the moment of the intersection a line 39 of beginning of the driver's visual visibility of an area (a border between a locality A and a locality B) are reflected on the video screen 14 in two ways: a rear their parts are visible on the top front part 38 of the screen 14, a front their parts the driver sees visual. Beyond of a yellow line 40, dividing the road on two opposite directions of the traffic, objects, which move against the car's 10 movement, and motionless objects, and also objects moving in the same direction with the car 10, but with a lesser speed—all these objects appear on the video screen 14 from above, and as the car 10 moves forward, they shift from top to bottom 38, and going to a lower edge of the video screen disappear from it. Objects, moving in the same direction and with the same speed as the car 10, remain on the video screen motionless, objects with the bigger speed shift on video screen from below 37 to up 38 and when are in front of the car 10 disappear from video screen, going into the zone of the driver's visual visibility (B).

In the video screen 14 middle of upper edge 38, there is a reflection of the car's 10 rear part, which looks like a motionless object, indicating on the permanent place on video screen of the car 10 regarding to surrounding objects.

On the video screen 14 around the car 10, it is to ring with a red stripe a zone C (its size in meters see FIG. 5), called the emergency zone because an appearance here of some object creates a threat to the car 10 in case of a mistaken maneuver. The zone C (FIG. 5) is divided symbolically in three sectors: right, left, and central, which are situated accordingly on the right and on the left of the car 10, and central at the back of it. In the time of back maneuvering during a park, a central sector on a zone C must be free from any objects. When an object, moving on one lane with the car 10 and behind it, crosses a red stripe in the central sector of a zone C, the driver of the car 10 doesn't have the right to reduce a speed owing to a short distance between them, and this situation threatens with an accident. By this reason (a short distance), for the driver of the car 10 there is forbidden to maneuver to the left, if an object moving on the left lane crosses a red stripe on the left sector of the zone C, and to the right, if an object moving on the right lane crosses a red stripe in the right sector. The singling out of the zone C has the great practical importance, indicating to a driver that here is close by a moving object, and this requires his increased attention in the time of a maneuvering with a car.

The installation of a video camera 11 with a wide-angle lens with an angle of an embracement no less than 120 degrees vertically above the windscreen 17 over the roof's 18 level (FIG. 1) allows to make a view of an area and objects on both sides of the car 10 within two lanes of a road (FIG. 6). On the video screen, there are objects 41, 42, 43, 44, 45, 46, moving on the side and at the back of the car 10 on a road, divided in four lanes with an intermittent white lines 57. Objects 45, 46, moving in a parallel on two lanes of a road on the level of the car 10, get into a double visibility—partly in zone A (the view of an area with video camera) and partly in zone B (a locality getting in a visual view). Objects, which are in front of the car 10, get in a visual field of vision.

From the arisen situation (see FIG. 6) thanks to the video camera, it is clear, that objects 42, 43, 44, 46, situated outside zone C and at a considerable distance of the car 10, don't present a danger for it, but objects 41, 45, which are close to it, can provoke an accident, if the car's 10 driver will maneuver incorrectly. An analysis of the reflected on video screen all setting around the car 10 helps in a choice of an optimum decision because discovering objects 41, 45 in the emergency zone C, the driver realizes, that at the given moment a replacement of the lane on the left or on the right threatens with a collision with indicated objects. At the same time, the reduction of a speed is safe because following after the car 10 an object 42 is out of zone C. Thus, an installation of the video camera in front of the windscreen enables for the driver to observe a motion of all objects around the car 10, to check a situation, and to seek for a safety of the traffic.

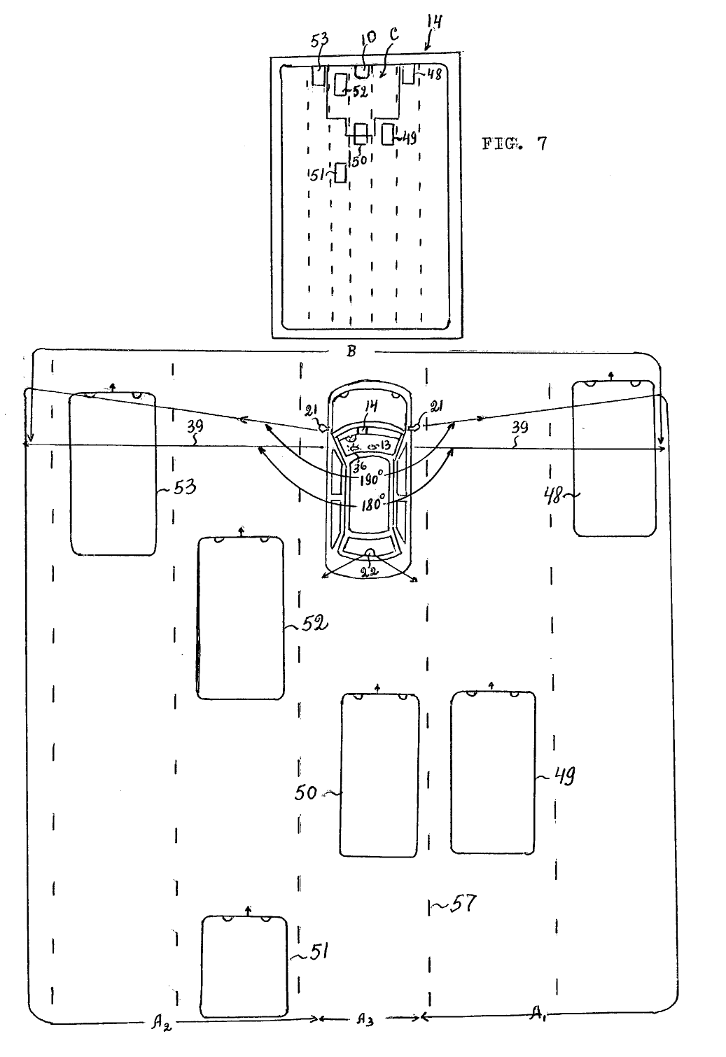

The installation of the video camera in front of the windscreen imparts to a car the strange outward appearance. But second version of an arrangement of cameras (see FIG. 2)—from the outside two laterally and one at the back—doesn't change the habitual appearance of a car. With this version of the installation of video cameras, as shown in FIG. 7, the zone of the driver's view of an area is divided symbolically in sectors A1 (left), A2 (right), and A3 (rear). On the video screen they form the united whole, owing to what a lateral and rear observation of an area broaden till 190-200 degrees, making viewable all from both sides of the car 10 with the partial passage into a zone of the driver's visual visibility (B).

According to FIG. 7, video cameras display, that objects 48, 49, 51, 53, situated at the considerable distance of the car 10, don't present a danger for it, but objects 50, 52, which are close to it, can provoke an accident, if the car's 10 driver will maneuver incorrectly. And just the analysis of data on the video screen about a situation around his car helps the driver to make a right decision. For instance, when he discovers an object 52 in the left sector of the emergency zone C, the driver doesn't have a right to change his lane on the left; when he discovers in the zone's C central sector an object 50, following on the same lane with the car 10 at the back of it, the driver doesn't have a right to reduce the speed owing to the treat of a collision with this object. At the same time, close situated objects 48, 49 don't create an accident situation during the replacement with the car 10 its lane on the right because they are out of the right sector of the emergency zone C.

Zone C is intended also for the safe maneuvering during the back way.

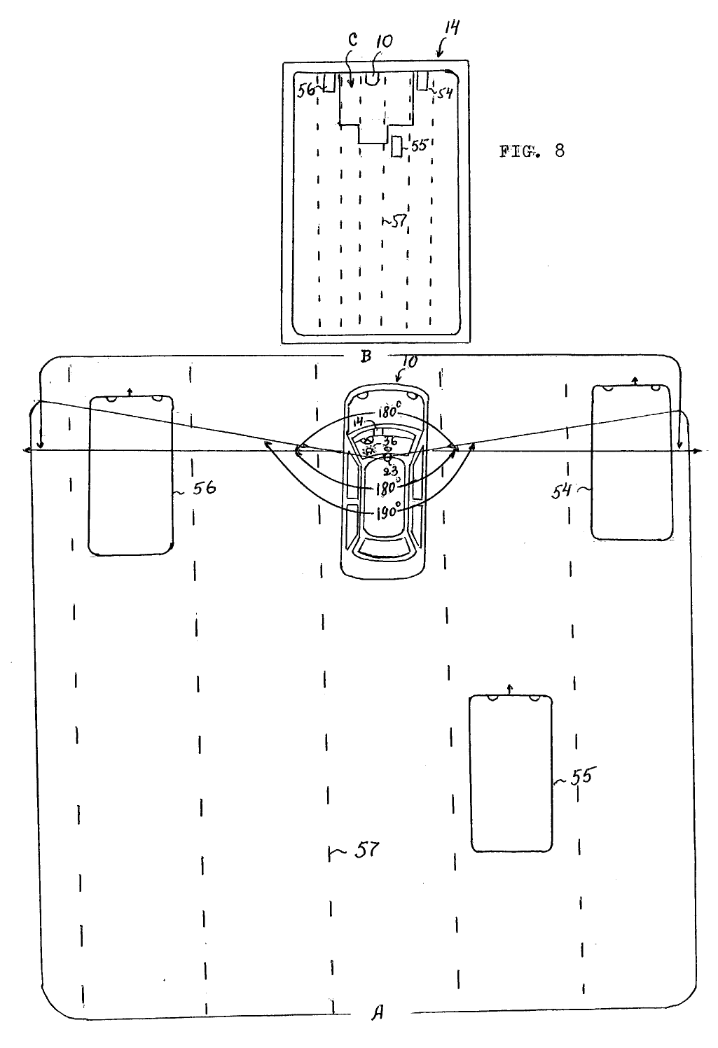

The installation of the video camera with a lens, combined from two or three parts, from the front and over the windscreen 17 (FIG. 3) ensure the view of an area A and situated on it objects 54, 55, 56 with the transmission all on the video screen 14 like the united whole broaden until 190-200 degrees around the car 10, and together with a field of vision in zone B this makes 360 (see FIG. 8).

For an observation of a car's saloon is used a near view mirror 13 (FIG. 2).

What is claimed is:

1. The present invention includes:
Video System as a new method, first enabling for a car's driver to achieve the sheer, without blind spots, lateral and rear view of an area;
for the first time attained the sheer view of an area in the immediate nearness and remote for a car, and in the combination with the front visual observation, a creation of the view on 360 degrees;
first allows for the driver, without turning his head and body, to see all that is going around his car; thanks to a reaching of a complete view of a locality, the decision of the practical problem of radical improvement of safe driving; and
the substitution with this new method of an existent now, but imperfect system of mirrors, accompanied by blind spots in a viewing with driver locality.

2. The invention Video System as a new method of ensuring the sheer view of an area around a car and the safety of driving includes:
the installation of video cameras outside of a car as the most important condition for the sheer, without blind spots, view of a locality;
the establishment in the video camera one or two wide angle lenses, reaching together the angle of a survey 190-200 degrees to widen the observation of a locality;
the installation in the video camera Night Vision Light-Emitting Diodes for an automatic adjustment of an even visibility in the night time;
the transmission from the video camera on the video screen, installed on an instrument panel in front of the car's steering wheel, the crystal clear color image of an area's relief and situated on it objects.

3. The invention Video System as a new method of ensuring the sheer view of an area around a car and the safety of driving, as defined in claim 2, wherein said about the video screen, includes:
the singling out on the video screen of a range-finder emergency zone, which enables a driver to form a correct estimate of the situation near the car and realize a maneuvering with it without the accidents.
